(19) United States
(12) Patent Application Publication
(10) Pub. No.: US 2003/0140247 A1
(43) Pub. Date: Jul. 24, 2003

(54) Method and system for securing a computer connected to an insecure network

(75) Inventors: Richard Marin, Evanston, IL (US); Joshua Landsman, Skokie, IL (US); M. Russell Bakke, Orange, CA (US)

Correspondence Address: GREER, BURNS & CRAIN, 300 S WACKER DR, 25TH FLOOR, CHICAGO, IL, 60606, US

(73) Assignee: SecureNet Technologies, Ltd.

(21) Appl. No.: 10/055,767

(22) Filed: Jan. 23, 2002

(51) Int. Cl. H04L 9/32

(52) U.S. Cl. 713/201

(57) ABSTRACT

The present invention relates to an improved method for securing a computer connected to an insecure network when the computer is not utilizing the insecure network, wherein the computer is installed with a program managing the connection with the insecure network, which includes the steps of determining whether the computer is active, deactivating the computer from the insecure network when it is determined that the computer is inactive, and waiting for a predefined time period to repeat the method.

The present invention generally relates to a method and system for securing a computer connected to an insecure network when the computer is not utilizing the insecure network. More specifically, it relates to a method and system for securing a computer connected to an insecure network when the computer is not utilizing the insecure network, wherein the computer is installed with a program managing the connection with the insecure network.

It is currently becoming more common for a typical computer to be connected to multiple networks at any given time. For example, a computer may be connected to an intranet via a local area network (LAN) or/and the Internet via a Digital Subscriber Line (DSL), a cable modem connection or a T connection. Because continuous connection to the Internet (i.e., insecure network) using these various connections is becoming the standard in the computer industry, a typical computer is vulnerable to unwanted connections or intrusions, such as hacker attacks, from the insecure network at any given time as long as the computer is turned on and hooked up to the Internet. Thus, a method to secure the computer from such unwarranted connections is needed to protect the computer from any potentially damaging intrusions.

There are currently several commercially available software programs, such as ZoneAlarm Pro® manufactured by ZoneLabs, San Francisco, Calif., McAfee Firewall® manufactured by Network Associates®, Inc., Santa Clara, Calif., Norton Internet Security 2002® manufactured by Symantec Corp.®, Cupertino, Calif., Norton Personal Firewall 2002® manufactured by Symantec Corp.®, Cupertino, Calif. and Blacklce Defender® manufactured by Defender Network ICE Corporation®, San Mateo, Calif., that place a firewall between the computer and the insecure network. In particular, the ZoneAlarm® program allows users to decide which applications can and cannot use the Internet. An Internet Lock is implemented in the ZoneAlarm® program for blocking Internet traffic while the computer is unattended or while the Internet is not being used. The McAfee firewall® program, on the other hand, filters all the applications, system services, and protocols, including file and printer shares (NetBIOS), IP protocols (TCP/IP, UDP/IP), service-based protocols (FTP, Telnet), ARP/RARP, and Dynamic Host Configuration Protocol (DHCP). Additionally, the firewall blocks the IPX and the NetBEUI on a per device basis.

The Norton Internet Security® 2002 program and Norton Personal Firewall® 2002 program offers a software program that blocks incoming hack attacks while allowing trusted applications to connect to the computer. Lastly, the BlackIce Defender® scans the DSL, cable modem or dial-up Internet connection for hacker activity. When an attempted intrusion is detected, the traffic from that source will be automatically blocked. As a result, any unwanted intrusion is avoided. In all these examples, the connection between the computer and the insecure network remains connected. Basically, all of the prior solutions filter the connection to the insecure network. In other words, while the computer is connected to the insecure network, the known programs provide a security system in front of the gateways or ports to the computer. The programs determine whether a requesting source is trusted or untrusted, and only the trusted sources are allowed access to the gateway or the ports.

The problem with these prior programs is that it is too difficult to literally list or identify all the trusted sources. As a result, they are generally riddled with multiple security leaks or shortcomings. As shown, there is a need for an improved method for securing the computer from the insecure network.

Accordingly, it is an object of the present invention to provide an improved security program which more completely protects computers from hazards borne by an insecure network.

### BRIEF SUMMARY OF THE INVENTION

The present invention is directed to an improved method and system for securing a computer connected to an insecure network when the computer is not utilizing the insecure network. More specifically, it relates to a method and system for securing a computer connected to an insecure network when the computer is not utilizing the insecure network, wherein the computer is installed with a program managing the connection with the insecure network.

The present invention provides a method for securing a computer connected to an insecure network when the computer is not utilizing the insecure network, wherein the computer is installed with a program managing the connection with the insecure network. The method includes the steps of determining whether the computer is active, deactivating the computer from the insecure network when it is determined that the computer is inactive, and waiting for a predefined time period to repeat the method.

Also, in another embodiment, the present invention provides a computer program product comprising a computer readable code stored on a computer readable medium that, when executed, the computer program product causes a computer to determine whether the computer is active, deactivate the computer from the insecure network when it is determined that the computer is inactive, and wait for a predefined time period to repeat the method.

### DESCRIPTION OF THE DRAWINGS

FIG. 1 is a schematic diagram of a network system in which the present method is implemented;

FIG. 2 is a flowchart illustrating an overall preferred method of the present invention;

FIG. 3 is a flowchart illustrating a preferred subroutine for the step of obtaining the address and status of the connection to the insecure network shown in FIG. 2,

FIG. 4 is a flowchart illustrating a preferred subroutine for the step of reactivating the insecure network shown in FIG. 2;

FIG. 5 is a flowchart illustrating a preferred subroutine for the step of deactivating the insecure network shown in FIG. 2;

FIG. 6 is a flowchart illustrating a preferred subroutine for the step of determining the status of the screen saver shown in FIG. 2; and

FIG. 7 is a flowchart illustrating a preferred subroutine for the step of determining whether any network process is active shown in FIG. 2.

### DETAILED DESCRIPTION

Broadly stated, the present invention is directed to a method and system for securing a computer connected to an insecure network when the computer is not utilizing the insecure network. Rather than simply filtering the requesting source through the connection to the insecure network, as proposed in the prior art, the present invention provides a way to completely deactivate the computer from the insecure network when the computer is not utilizing the insecure network. Thus, there is no need to filter the requesting sources, because once the computer is deactivated from the insecure network, no data is allowed to be received or transmitted through the insecure network. Any communication through the insecure network is completely disabled. As a result, any security leaks to the system would be greatly reduced by the present invention, and the network security is improved.

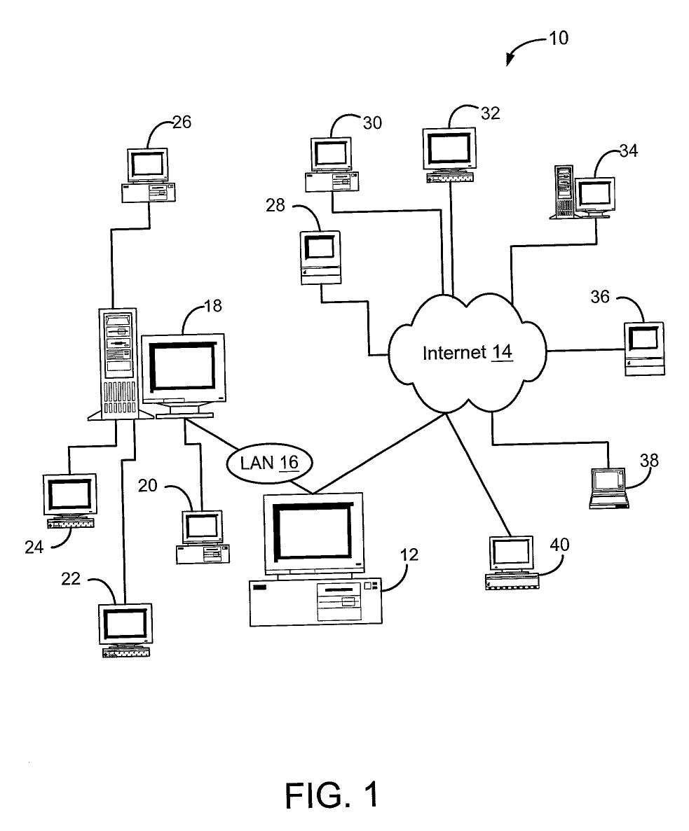

A schematic diagram of a network system is shown in FIG. 1, and indicated generally at 10. A computer 12 is shown to be connected to the Internet 14 (i.e., insecure network) and a LAN 16 (secure network) running an intranet via a computer server 18. As shown, there are multiple computers 20, 22, 24, 26 including the computer 12, which are referred to as client computers, connected to the computer server computer 18. The Internet 14 also shows multiple computers 28, 30, 32, 34, 36, 38, 40 including the computer 12. However, in practice, the Internet generally includes millions of computers connected at any given time, but, for simplicity, only 8 computers are shown. As a result of these various unidentified computers connected to the Internet, the computer 12 is very vulnerable to unwanted connections, such as from hackers or transmitters of potentially disabling computer viruses.

Although the insecure network shown 10 is preferably connected to the Internet, other types of networks can certainly be used in conjunction with the Internet or even in place of it. For example, the network connection may include other Wide Area Networks (WANs) or even LANs. The present invention can be implemented with any type of network that is considered insecure, and these other implementations should be apparent to one skilled in the art.

However, because the network system 10 is contemplated as varying greatly in types, complexity and size, an explanation of the current preferred embodiment of the network topology is given for clarification purposes. Thus, simply as an example, a computer 12 installed with the Microsoft® Windows® operating system having a continuous connection to the Internet (i.e., insecure network) will be used as an example in describing one implementation of the present invention. However, other implementations with different software programs, such as network security programs, network programs or operating systems, are contemplated, and they are considered to be within the scope of the present invention.

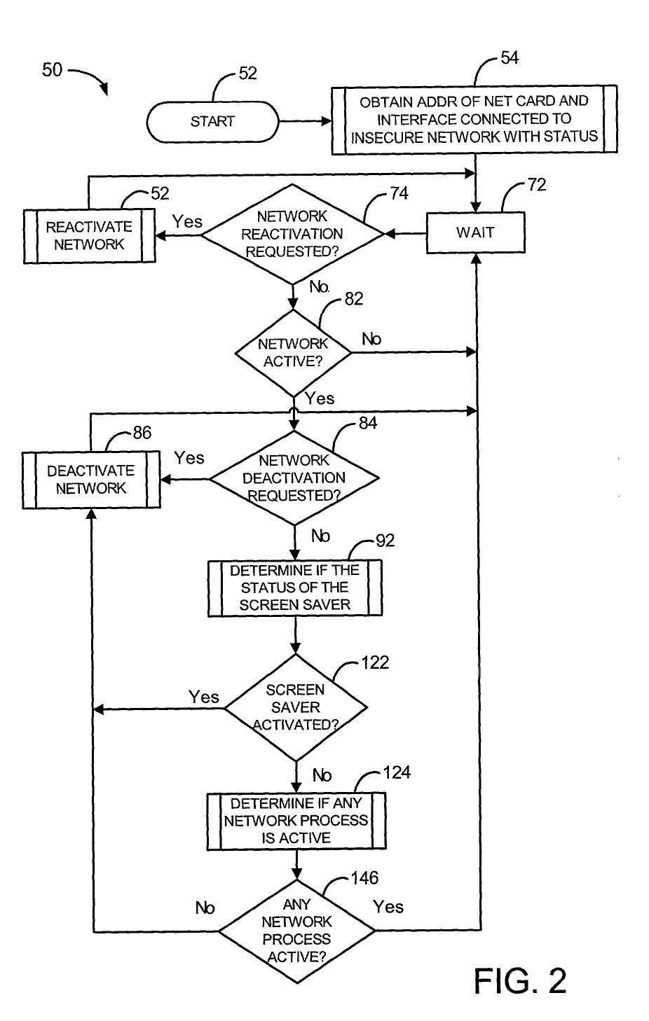

Turning to an important aspect of the illustrated embodiment of the present invention, a flow chart of the preferred functionality of the illustrated embodiment of the present invention is shown in FIG. 2, and is indicated generally at 50. The present invention is preferably implemented as an executable software program within the program controlling the connection to the insecure network. However, other implementations, such as firmware or hardware, are contemplated, and it should be understood that these other implementations are considered to be within the scope of the present invention.

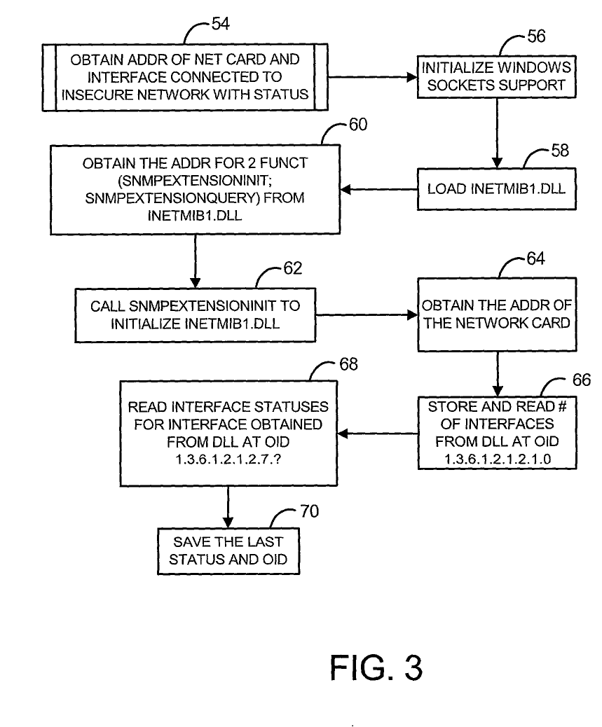

At the start of the method (e.g., the execution of the software program implemented with the present invention) (block 52), an address of the network card and the interface connected to the insecure network along with its status are preferably obtained (block 54). The preferred steps of the subroutine for this step (block 54) is shown in FIG. 3.

Turning to FIG. 3, the first step in the Windows® environment is to first initialize the Windows® sockets support or driver (block 56), followed by a step of loading a “INETMIB1.DLL” file or driver (block 58). After this, two addresses for two functions of SNMPEXTENSIONINIT and SNMPEXTENSIONQUERY are obtained from the INETMIB1.DLL (block 60). The SNMPEXTENSIONINIT function is then called in order to initialize the INETMIB1.DLL file (block 62). After the INETMIB1.DLL is initialized (block 62), the address (e.g., the object identifier) of a network card (e.g., 1.3.6.1.2.1.2.1.0) is now obtained (block 64). Next, the number of the interface(s) at the address of the network card (e.g., 1.3.6.1.2.1.2.0) is read from the INETMIB1.DLL file (block 66) and stored in memory. The status of the interface is also read at this time at the address or object identifier of the interface (e.g., 1.3.6.1.2.1.2.7.?) (block 68). Note that a question mark (?) has been used to indicate the address of the interface, because the actual address is not known, since the address of the interface is a variable generated at the time when the connection is made. Once all the information is obtained, the last status and the address/object identifier of the interface is then saved into memory (block 70).

Turning back to FIG. 2, after the address of the network card and the interface connected to the insecure network along with its status are obtained (block 54), the next step is to wait for a predefined time period (block 72), which can be implemented according to the computer engineers' desire. Nevertheless, the time out period is preferably less than 30 seconds in order to ensure that the computer is constantly checked for deactivation from the insecure network. After waiting for the predefined time out period (block 74), the method 50 will then determine whether there is a network reactivation request (block 74). In the present invention, this command is preferably requested through a user interface by users, but it is also contemplated that other programs in the system may request the network reactivation as well. For example, when a program installed on the computer makes a request to utilize the insecure network, a command to reactivate the network can be generated automatically in the present invention. As a result, even if the user does not directly request the reactivation, it is contemplated that other programs, nevertheless, can trigger the reactivation or deactivation of the insecure network in the present invention. Again, these other various implementations are within the scope of the present invention.

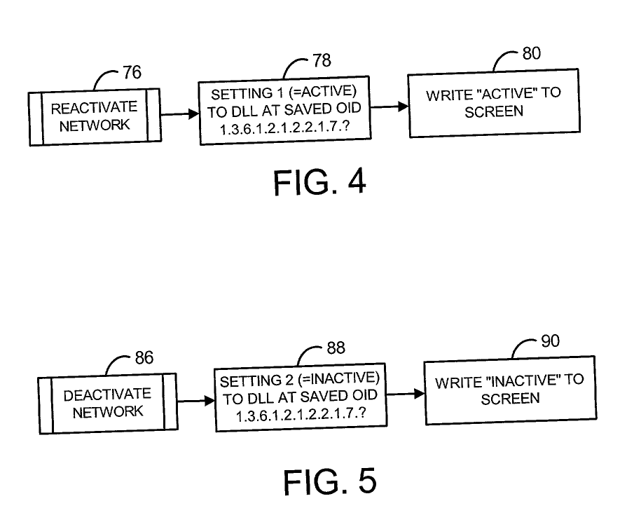

If there is a request to reactivate the network (block 74), the subroutine for reactivating the network (block 76) in the Windows® environment is shown in FIG. 4. Thus, turning for a moment to FIG. 4, the computer can be reactivated by setting the address/object identifier of the interface to “1” for an active status (block 78). Since the reactivation request is preferably generated by the user, it is preferable that a message indicating that the insecure network is active is prompted or displayed on the computer (block 80). From this step, going back to FIG. 2, the process will be repeated from the step to wait for a predefined time (block 72). On the other hand, if there is no network reactivation requested (block 74), the process continues to the next step of determining whether the insecure network indicates an active status (block 82). In other words, the method 50 checks to determine whether the insecure network has already been deactivated. If not (block 82), the process will be repeated from the step of waiting for a predefined time (block 72).

Otherwise, if it is determined that the insecure network is currently active (block 82), the process continues to the next step of determining whether there is a network deactivation request in the system (block 84). Similar to the reactivation, any network deactivation is preferably generated from the user interface by users. However, it is also contemplated that the network deactivation request can be generated by other programs in the system. Thus, these various other implementations are contemplated as being within the scope of the present invention. If a network deactivation has been requested (block 84), a network deactivation subroutine (block 86) shown in FIG. 5 will be executed.

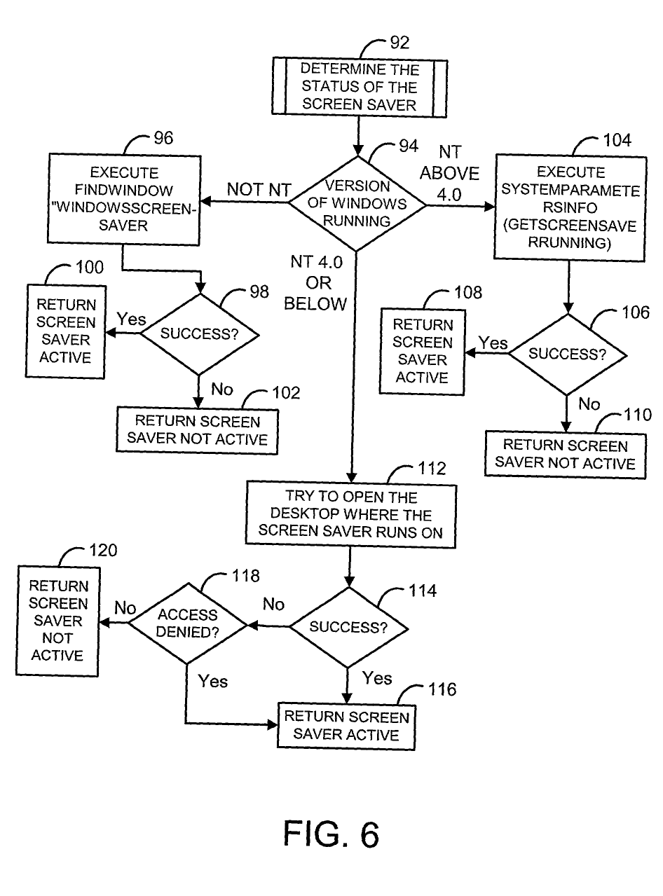

Referring to FIG. 5, the first step of the network deactivation subroutine (block 86) executed from FIG. 2 is to set the address/object identifier of the interface to “2” for an inactive status (block 88). Since the reactivation request is preferably generated by the user, it is preferable that a message indicating that the insecure network is active is prompted or displayed on the computer (block 90). From this step, going back to FIG. 2, the process will be repeated from the step of waiting for a predefined time (block 72). On the other hand, if there is no network reactivation requested (block 74), the process continues onto the next step of determining the status of the screen saver (block 92). In other words, the screen saver is checked to see if it is activated, and an explanation of the subroutine of this step is shown in FIG. 6.

Turning now to FIG. 6, in order to determine whether the screen saver is active (Block 92), it must be first determined whether the current version of Windows® is running on the computer 12 (block 94), which then separates into three different versions. If the version is not Windows NT®, the “FINDWINDOW” function is executed to find a “WINDOWS-SCREENSAVER” command (Block 96). If the “WINDOWS-SCREENSAVER” command is found (block 98), a determination of the screen saver being active is returned (block 100) back to the process shown in FIG. 2. Otherwise, a determination of the screen saver being not active is returned (block 102) to the process shown in FIG. 2.

If it is determined that the current version of Windows® is a NT version that is newer than 4.0 (block 94), a “SYSTEMPARAMETERSINFO” function is executed to find a “GETSCREENSAVERRUNNING” command (block 104). Similarly, if the “GETSCREENSAVER-RUNNING” command is found (block 106), a determination that the screen saver is active is returned (block 108) to the process in FIG. 2. Otherwise, a determination of the screen saver being not active is returned (block 110) to block 122 in FIG. 2.

If it is determined that the current version of Windows® is a NT version 4.0 or older (block 94), there is an attempt to open the desktop of the computer 12 where the screen saver is running on (block 112). If the attempt to open the desktop is successful (block 114), a determination that the screen saver is active is returned (block 116) to block 122 in FIG. 2. Otherwise, it must be determined whether access has been denied by the program (block 118). If, in fact, access has been denied (block 118), a determination of the screen saver being active is returned (block 116). On the other hand, if access has not been denied (block 118), a determination of the screen saver being not active is then returned (block 120).

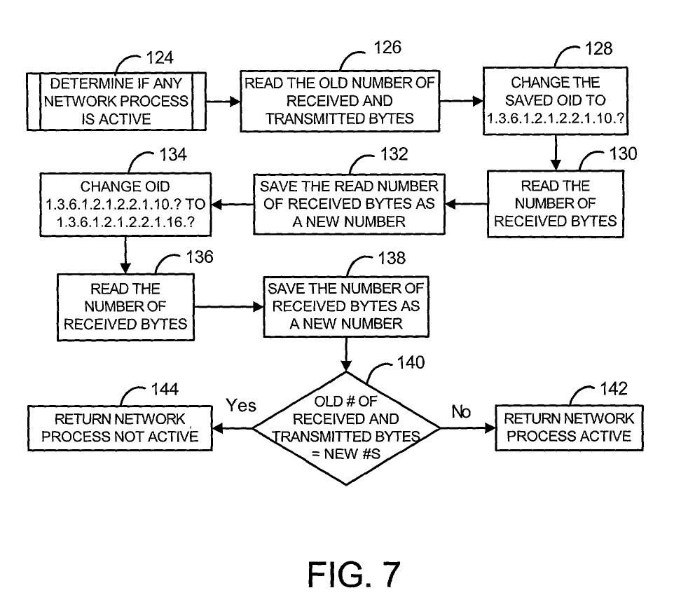

Turning back to FIG. 2, once it is determined whether the screen saver has been activated (block 92) from FIG. 6, in the case when the screen saver is activated (block 122), the insecure network will be deactivated, which is previously illustrated in FIG. 5. Otherwise, the process continues to the next step of determining whether there is any active network process currently running (block 124), which is explained using FIG. 7.

Turning now to FIG. 7, to determine whether any active network process is currently running on the system in the Windows® environment, the first step is to read an old number of received bytes and transmitted bytes (block 126), which is a number saved from the previous run through the process. If, however, this is the first time the process is has been run, the old number will be preferably zero. Next, the obtained address of the interface/object identifier (e.g., 1.3.6.1.2.1.2.7.?) must be changed to an address/object identifier (e.g., 1.3.6.1.2.1.2.10.?) (block 128) for obtaining or reading the number of bytes received during this process (block 130), which is then saved as a new number (block 132). Similarly, to obtain the number of bytes transmitted, the obtained address of the interface/object identifier (e.g., 1.3.6.1.2.1.2.10.?) is changed to an address/object identifier (e.g., 1.3.6.1.2.1.2.16.?) (block 134) for obtaining or reading the number of bytes transmitted during this process (block 136). The obtained number of bytes transmitted is again saved as a new number (block 138). The old numbers of the received bytes and the transmitted bytes are then compared to the new numbers obtained (block 140). If the old numbers are equal to the new numbers (block 140), a determination that a network process is currently active and running is returned (block 142) to FIG. 2. If, however the old numbers do not equal the new numbers (block 140), a determination that a network process is currently active and running is returned (block 144) to FIG. 2.

Finalizing the process, after it is determined whether any active network process is currently running (block 124), the insecure network is deactivated (block 86) if it is determined that an active network process is currently running (block 146). On the other hand, if no active network is currently running in the system (block 146), the process reloops back to wait for a predefined time to restart the process (block 72).

From the foregoing description, it should be understood that an improved method and system for securing a computer connected to an insecure network have been shown and described, which have many desirable attributes and advantages. The present method and system provide a way to completely deactivate the computer from the insecure network when the computer is not utilizing the insecure network. Thus, there is no need to filter the requesting sources, as done in the prior art, because once the computer is deactivated from the insecure network, no data is allowed to be received or transmitted through the insecure network no matter what the requesting source may be. Any communication through the insecure network is completely disabled. As a result, any security leaks or shortcomings in the system would be greatly reduced by the present invention, and network security is improved.

It should be noted that, although a preferred method has been shown with certain order, it would be apparent to one skilled in the art that the order of the steps can be changed, and the steps, themselves, can be slightly altered. In addition, new steps can be added as well. These variations in alternating the preferred method is apparent to one skilled in the art, and the present invention is not limited to the method shown. Thus, it should be understood that other variations of the preferred method shown is contemplated and within the scope of the present invention.

While various embodiments of the present invention have been shown and described, it should be understood that other modifications, substitutions and alternatives are apparent to one of ordinary skill in the art. Such modifications, substitutions and alternatives can be made without departing from the spirit and scope of the invention, which should be determined from the appended claims.

Various features of the invention are set forth in the appended claims.

What is claimed is:

1. A method for securing a computer connected to an insecure network when the computer is not utilizing the insecure network, wherein the computer is installed with a program managing the connection with the insecure network, the method comprising the steps of:
determining whether the computer is active;
deactivating the computer from the insecure network when it is determined that the computer is inactive; and,
waiting for a predefined time period to repeat the method.

2. The method according to claim 1 further comprising the step of displaying the current status of the insecure network on the computer.

3. The method according to claim 1 further comprising the steps of:
obtaining an address for the network card;
obtaining an address for an interface connected to the insecure network using the obtained address of the network card; and,
obtaining the status of the obtained address of the interface.

4. The method according to claim 3 wherein said step of obtaining an address further comprises the steps of:
initializing any sockets support in the program managing the insecure connection;
loading a driver having an object identifier of the program managing the insecure connection;
obtaining an address for the initialization function and an address for the query function from the program; and,
calling the initialization function to initialize the driver.

5. The method according to claim 4 wherein said step of obtaining an address for an interface connected to the insecure network further comprises the steps of:
determining a total number of interface(s) using the obtained address of the network card; and,
storing the obtained total number of interface(s) in temporary memory.

6. The method according to claim 5 wherein said step of obtaining the status of each obtained address of the interface further comprises the steps of:
reading the status of the obtained address of the interface; and,
saving the obtained address of the interface with the read status to memory.

7. The method according to claim 3 wherein said step of deactivating the computer from the insecure network further comprises the step of setting each obtained address of the interface to an inactive status.

8. The method according to claim 1 further comprising the steps of:
determining whether there is a network reactivation request; and,
reactivating the computer on the insecure network when there is a network reactivation request.

9. The method according to claim 1 further comprising the steps of:
determining whether there is a network deactivation request; and,
deactivating the computer from the insecure network when there is a network deactivation request.

10. The method according to claim 3 wherein prior said step of determining whether the computer is active further comprises the steps of:
determining whether the obtained address of the interface connected to the insecure network has an active status; and,
waiting for a predefined time period to repeat the method when the obtained address of the interface has a nonactive status.

11. The method according to claim 1 wherein said step of determining whether the computer is active further comprises the steps of:
determining whether there is any active network process currently running via the insecure network when it is determined that the computer is active;
deactivating the computer from the insecure network when it is determined that there is no active network process currently running via the insecure network; and,
waiting for a predefined time period to repeat the method when it is determined that there is an active network process currently running via the insecure network.

12. The method according to claim 11 wherein said step of determining whether there is any active network process currently running further comprises the steps of:
obtaining an address for the network card;
obtaining an address for an interface connected to the insecure network using the obtained address of the network card;
reading an old number of received and transmitted bytes over the obtained address of the interface;
changing the obtained address of the interface to an address for obtaining the number of bytes received;
reading the number of bytes received;
saving the read number of bytes received as a new number;
the obtained address of the interface to an address for obtaining the number of bytes transmitted;
reading the number of bytes transmitted;
saving the read number of bytes transmitted as a new number;
determining whether the old numbers of received and transmitted bytes equal to the new numbers of received and transmitted bytes;
returning a determination that an active network process is currently active when the old numbers do not equal the new numbers; and,
returning a determination that no active network process is currently running when the old numbers equal the new numbers.

13. The method according to claim 1 wherein said step of determining whether the computer is active is performed by a step of determining whether the screen saver is activated on the computer.

14. The method according to claim 13 wherein said step of determining whether the screen saver is activated further comprises the step of determining the current version of a Microsoft Windows® operating system installed on the computer.

15. The method according to claim 14 wherein when the current version of Microsoft Windows® is not Windows NT, the method further comprising the steps of:
executing the findwindow function to find windowsscreensaver;
determining whether the windowsscreensaver is found by the findwindow function;
returning a determination that the screen saver is active when the windowsscreensaver is found; and,
returning a determination that the screen saver is not active when the windowsscreensaver is not found.

16. The method according to claim 14 wherein when the current version of Microsoft Windows® is Windows NT version 4.0 or later, the method further comprising the steps of:
executing a systemparametersinfo function to find getscreensaverunning;
determining whether the getscreensaverrunning is found by the systemparametersinfo function;
returning a determination that the screen saver is active when the getscreensaverrunning is found; and,
returning a determination that the screen saver is not active when the getscreensaverrunning is not found.

17. The method according to claim 14 wherein when the current version of Microsoft Windows® is Windows NT version 4.0 or older, the method further comprising the steps of:
opening a desktop of the computer where the screen saver runs on;
determining whether opening the desktop is successful;
returning a determination that the screen saver is active when the opening of the desktop is successful;
determining whether access to the desktop has been denied when the opening of the desktop is not successful;
returning a determination that the screen saver is not active when access to the desktop has not been denied; and,
returning a determination that the screen saver is active when the access to the desktop has not been denied.

18. A system for securing a computer connected to an insecure network when the computer is not utilizing the insecure network, wherein the computer is installed with a program managing the connection with the insecure network, the system comprising:
means for determining whether the computer is active;
means for deactivating the computer from the insecure network when it is determined that the computer is inactive; and,
means for waiting for a predefined time period to repeat the method.

19. A computer program product comprising a computer readable code stored on a computer readable medium that, when executed, the computer program product causes a computer to:
determine whether the computer is active;
deactivate the computer from the insecure network when it is determined that the computer is inactive; and,
wait for a predefined time period to repeat the method.
